(19) United States
(12) Patent Application Publication
(10) Pub. No.: US 2005/0164679 A1
(43) Pub. Date: Jul. 28, 2005

(54) Apparatus and method for sending image data

(75) Inventor: Paul Rowland Beardow, Egham, Surrey (GB)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Superscape Group plc, Hook (GB)

(21) Appl. No.: 10/503,344

(22) PCT Filed: Jan. 31, 2003
(86) PCT No.: PCT/GB03/00407

(30) Foreign Application Priority Data
Feb. 2, 2002 (GB) 0202460.2

(51) Int. Cl. H04M 3/00

(52) U.S. Cl. 455/412.1; 455/418

(57) ABSTRACT

A receiving device in the form of a mobile telephone (10) within a mobile network (12, 14, 16, 18) receives images from a server (18). The server (18) first determines the characteristics of the mobile telephone (10), such as receiver memory capacity, display size, receiver colour depth, receiver processor availability and receiver display resolution. The server 18 then selects a version of the image, to be sent to the mobile telephone (10), suitable for use by that style of mobile telephone (10). The server (18) also determines the bandwidth of the channel to the mobile telephone (10), and can adjust the depth of colour, resolution, and frame rate in the signal sent to the mobile telephone (10) further to accommodate the bandwidth and any limitations in the mobile telephone (10).

The present invention relates to the transmission of image related material to a displaying device. The present invention, in particular, relates to the provision of an image to a mobile telephone device.

Progressive improvement in mobile telephone devices has meant that the need to provide images has increased sharply at the same time that increased numbers of clients have been recruited. This has caused enhanced competition for bandwidth. Mobile telephony schemes have been proposed where the available bandwidth to each new subscriber on a base station decreases as the instant number of subscribers grows. This means that the bandwidth available to contact a mobile telephone device varies with time. The present invention seeks to provide means whereby a mobile telephone device can receive an image representative signal, in real time if need be, despite the uncertainty of the bandwidth allocated to a mobile telephone device.

Equally, many different types of mobile telephone device exist. Some have big screens. Some have small screens. Some have high definition screens. Some have coarse definition screens. Some have high refresh (frame repetition) rates. Some have low refresh rates. Some have a great capacity to display depth of colour. Some have a lesser or non existent capacity to display colour. If the same bandwidth were allocated to each mobile telephone device, the ability of some devices would be under exploited and the ability of other devices over estimated. The present invention presents a means whereby the abilities of devices can be matched to the resources made available to each device.

Not all situations allow each device to exploit its full potential. As the number of subscribers per base station increases, so the bandwidth and resources allocatable to a particular device can reduce below that limit where the device is fully functional according to its full specification. The present invention seeks to provide a means whereby the signal, sent to a particular mobile telephone device, can be tailored to produce a tending to optimal output from the device under the reduced bandwidth conditions.

The present invention consists in an apparatus for sending an image related signal to a receiving device, said apparatus comprising: means for learning the characteristics of the device: means for employing said learned characteristics to select a version of said image related signal; means to create said version of said image related signal; and means for sending said version of said image related signal to said device.

The invention also provides means for determining the bandwidth of the medium connecting said apparatus and said device, and for adjusting characteristics of said version of said image related signal for the adjusted version of the image related signal to fit within the determined bandwidth.

The invention also provides means for determining the sending capacity of the apparatus.

The invention also provides that the characteristics, learned about said device, can include one, some or all of: receiver memory capacity; receiver display size; receiver colour depth; receiver processor availability and receiver display resolution.

The invention further provides that the adjustable characteristics can be one, all or some of: depth of colour; resolution or frame rate.

The invention further provides that the device can be a mobile telephone, a computer device or a television device.

The invention is further explained, by way of example, by the following description, taken in conjunction with the appended drawings, in which:

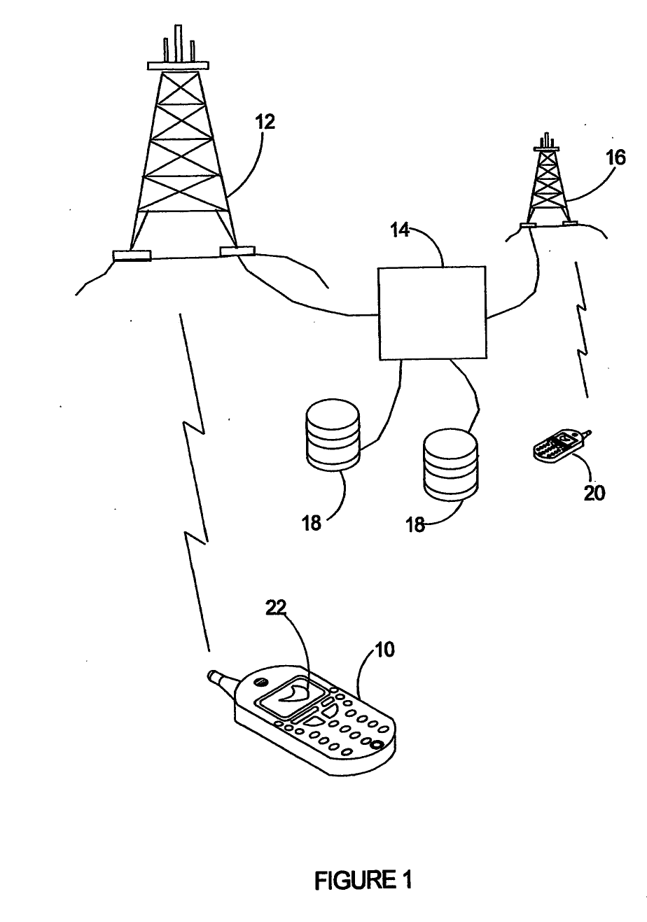

FIG. 1 is a schematic diagram illustrating the environment within which the preferred embodiment of the present invention is practised.

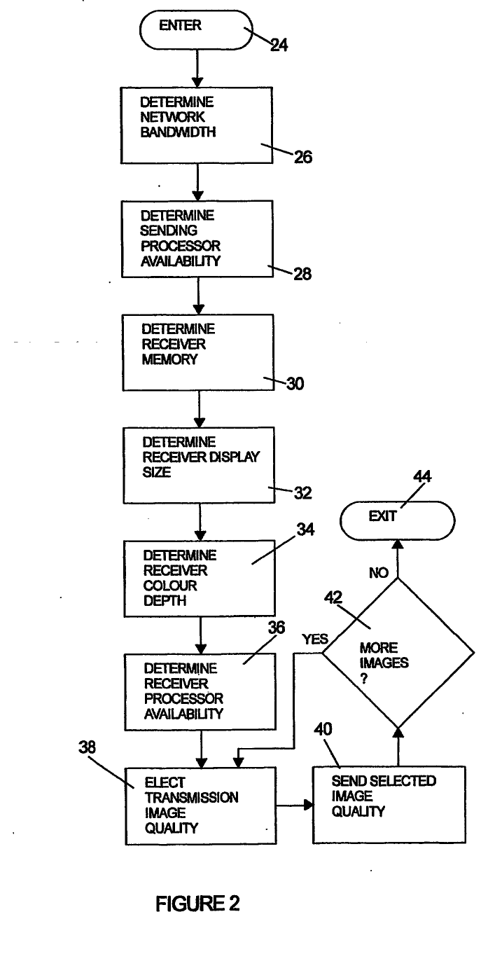

FIG. 2 is a flow chart showing, in general terms, how a transmitting device, operating according to the present invention, behaves.

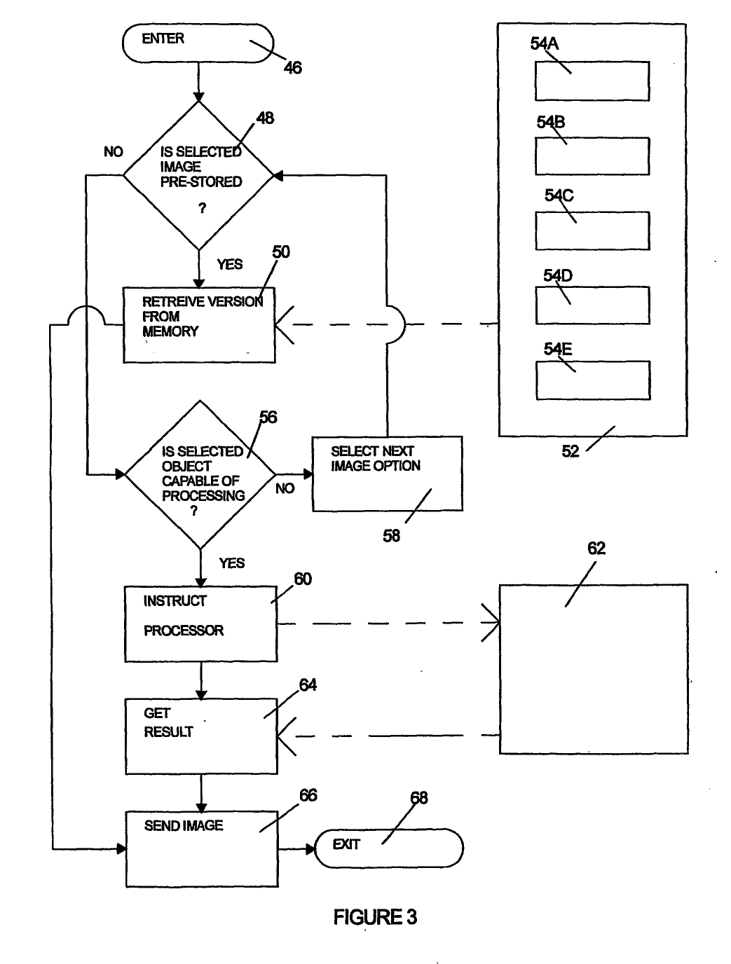

FIG. 3 is a flow chart showing one way in which a transmitting device would select an image to be transmitted.

And

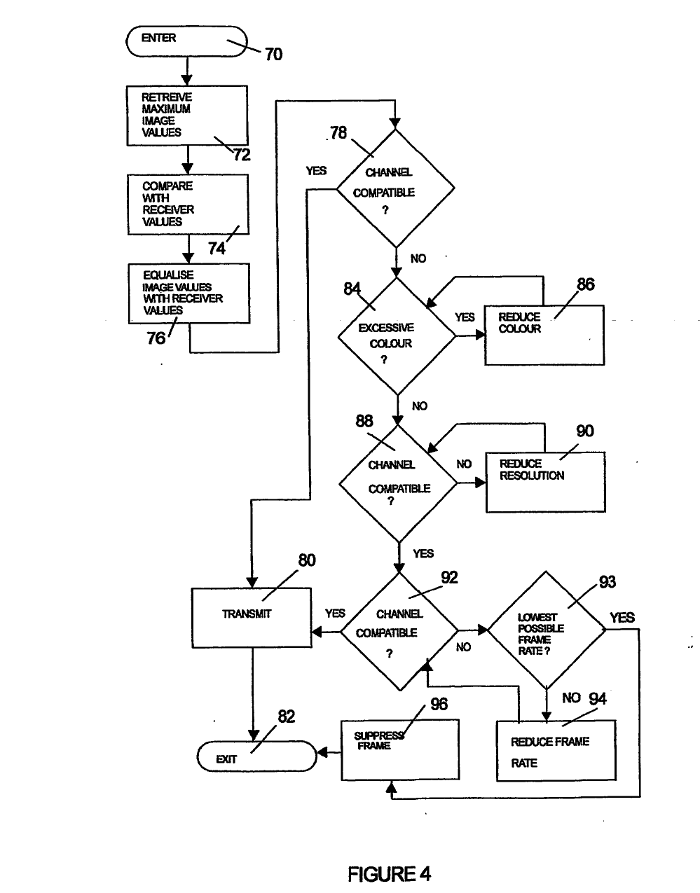

FIG. 4 is a flow chart illustrating how a transmitting device tailors the selected transmission to match the receiving device and the available channel bandwidth.

Attention is drawn to FIG. 1, showing the general environment in which the preferred embodiment of the invention is practised.

A mobile telephone 10 is in radio communication with a mobile telephone network base station 12 which is, in turn, connected via the terrestrial telephone network 14 to other base stations 16 and one or more servers 18. The terrestrial telephone network 14 can comprise land lines, high band width cables, and microwave and satellite links. The terrestrial telephone network 14 allows connection to other mobile telephones 20, fixed telephones and fixed computer terminals. A mobile telephone 10 can access a server 18 for data, information and other resources. A server 18 can provide a mobile telephone 10 with images to display. The base stations 12 can be on any style or generation of mobile telephone system, provided it has the ability to display an image. The mobile telephone 10 comprises a screen 22 capable of displaying images.

The mobile telephone 10 is the preferred method of trans mission and reception in the chosen embodiment of the present invention. It is to be appreciated that the present invention encompasses any means for sending and receiving images and is not limited to mobile telephones 10, 20 or a mobile telephone network 12, 14, 16. The present invention equally allows personal digital assistants (PDA), televisions, computers and computer terminals to receive images through any other system including, for example, a wire or cable system or by satellite. The example of a mobile telephone is merely given as an apt application for the present invention.

Attention is drawn to FIG. 2, a flowchart showing the general activity of a transmitting device such as the server 18 of FIG. 1, when functioning within the present invention.

As an example, the server 18 is charged with providing a frame of a moving image to a mobile telephone 10. The server 18 might, equally well, have been charged with sending a static image, a constructed scene, or any other pictorial representation. This example is merely chosen as being a more usual and demanding application for the system.

From an entry 24, a first operation 26 has the server 18 determine the network bandwidth. As earlier indicated, depending upon the number of subscribers on each base station, the network bandwidth may be larger or smaller. In general terms, the network bandwidth will be allocated as a reasonably high fixed figure, which is only reduced, on each base station, when the number of subscribers exceeds a predetermined limit on each base station. Different base stations can have different band widths. Equally, the present invention permits that not only the radio link from each base station, but also the land line connection to and from a base station, may also be subjected to bandwidth limitation when many subscribers are present. The bandwidth can be measured or, more usually, will arise as a result of the operating parameters of the system being set, and be a value of which the server 18 will simply be informed.

The first operation 26 having determined the bandwidth available for the server 18 to transmit its moving imageframe, a second operation 28 determines the sending processor availability. That is to say, if a frame of a moving image of particular size or complexity is to be sent, a certain, minimum amount of processor activity will be required at the server. Now, the server is simultaneously servicing many other base stations, and has, in addition, to perform many other tasks. It may be that the processor in the server 18 is not actually capable of handling that frame transmission activity given all of the other tasks which it is required to do. It is therefore essential to know, in advance, whether or not the processor in the server 18 is instantly capable of performing the task, and, if not, just what task it is capable of performing. The second operation 28 discovers what server processor resources can be allocated for the transmission task.

This done, a third operation 30 determines the receiving device memory. It may be that the mobile telephone 10 which, in this example, is acting as a receiving device, has a particularly large memory footprint. In this case, it will be capable of receiving complex and elaborate images. On the other hand, it is possible that the receiving mobile telephone 10 has only a very small memory footprint. In this case, the receiving mobile telephone 10 will be capable only of receiving a low resolution image. There is no point in sending a huge file to a small memory. The memory will simply be unable to hold the file. Equally, it would be a pity to lose the chance to display a truly detailed image by not sending a large file to a memory which is quite capable of containing that file. The size of the memory footprint in a receiving device can be determined not only by the amount of storage present, but can be reduced by memory usage for other tasks.

Once the receiving device memory availability is known, a fourth operation 32 determines the receiver display size. At one extreme, the receiving mobile telephone 10 might have a physically large screen with a high pixel density. On the other extreme, the receiving mobile telephone 10 might have a display of small size and of a coarse pixel density. There is no point in attempting to display an image of a high pixel density on a coarse resolution screen. The pixels have to match. Screens 22 can have different numbers of rows and columns of pixels. The transmitted frame has to be compatible with the pixels on the screen 22 of the receiving device 10.

Once the receiving device's screen details are known, a fifth operation 34 determines the receiving mobile telephone 10's depth of colour.

The display 22 may merely be black and white, in which case there will be, transmitted, for each pixel, a brightness number consisting of a predetermined number of binary digits (bits) which determine the grey scale. At the low resolution end, a four binary digit number allows for a grey scale with 16 levels of lightness. An eight binary digit number allows for a grey scale with 256 levels. Grey scales are known which use twelve, twenty-four, thirty six and even larger numbers of binary digits.

On the other hand, the display 22 may be a full colour display 22. In general, in colour displays, each pixel has a hue (the exact shade of its colour) and a saturation (the proportion of the coloured light which is not white). In current technology, it is general to approximate the hue and saturation of a pixel using different intensities of three colours. The pixel itself comprises three visible points which make up a full colour pixel, the three points being so close together that, at a viewing distance, they confuse the eye into a sense of unity.

In radiative displays, the colours are the radiative primary colours of red, blue and green. To make a near perfect range of hues and saturations for a pixel, it is simply necessary to mix together different proportions of these three lights. For example, no red, no green and no blue is equivalent to black. Full red, full green and full blue is full intensity white. Half red, half blue and half green is half intensity white (grey). Full red is one hundred percent saturated red. Full red, one third green and one third blue are fifty percent saturated red (pillar box red). All manner of hues and saturations are possible in between.

In representing the colour of a pixel, each of the red, green and blue lights is represented by a proportion of its full intensity. That proportion is represented by a number which is given by a string of binary digits. The more binary digits present in the string, the finer the resolution of the intensity of each light. In some, low resolution, systems, there may be only 16 levels of intensity for each primary colour. In the most sensitive current systems, it may take 42 binary digits (bits) to represent the intensity of each primary colour.

With the colour depth having been discovered, a sixth operation 36 determines the receiving mobile telephone's 10 processor availability. At one extreme, the data processor in the receiving mobile telephone 10 may be wide, fast and hardly used. At the other extreme, the processor in the receiving mobile telephone 10 may be narrow, slow and hard pressed. The state of the processor in the receiving mobile telephone 10 largely determines what it will be possible to ask the receiving mobile telephone 10 to do to an image signal before it is displayed.

Having determined all of these features of the receiving mobile telephone 10, of itself (the server 18) and of the network, the server 18, in a seventh operation 38, then elects the transmission image quality. That is to say, in a manner which is later explained in detail, a signal quality is determined which is close to the optimal signal quality which could be sent over the network, within the available bandwidth, to that particular receiving mobile telephone 10.

An eighth operation 40 then sends an image the selected image quality. The first test 42 terminates the operation in exit 44 if no further matter is to be sent, or passes control back to the seventh operation 38 if more images or frames are to be sent from the server 18 to the receiving mobile telephone 10.

The various circuit and receiver parameters determined in the first operation 26 to the sixth operation 36 can be determined by consulting a pre-loaded memory containing facts about particular types of mobile telephone 10, can be determined by actual measurements, or can be learned by receiving instructional updates from the base station 12 as the available bandwidth, for example, is racked up and down. In third generation systems, where connection is permanent, the mobile telephone network 14 would know, all of the time, the nature of the mobile telephone 10 which is connected to a particular subscriber slot.

Attention is drawn to FIG. 3, showing a flowchart, roughly corresponding to the seventh operation 38 of FIG. 2, showing how the server 18 can select the image quality to be sent to the receiving mobile telephone 10.

From entry 46, a second test 48 looks to see if a copy of the frame of the selected image quality is pre-stored. If a frame of the selected image quality is pre-stored, a ninth operation 50 has the server 18 retrieve the required frame from an image store 52. The required image is selectable one from among a plurality of stored images of differing qualities 54A, 54B, 54C, 54D, 54E. Each of the stored image qualities, 54A-54E has a differing quality from all of the others. One image 54B, for example, may have a smaller number of pixels. Another, 54C, may have a lesser depth of colour (number of bits defining hue and saturation). All of the stored images 54A-54E represent a different image frame, each suitable for a particular style of receiving mobile telephone 10.

If the second test 48 does not detect that the selected image is pre-stored, a third test 56 checks to see if the selected image is capable of being derived by image processing. If it is not, a tenth operation 58 selects another image option and returns control to the second test 48.

If the third test 56 determines that the selected image is capable of being generated by processing, an eleventh operation 60 provides the on-board processor 62 with all of the instructions necessary to generate a signal of the required image quality. Thereafter, the eleventh operation 60 passes control to a twelfth operation 64 which receives the results back from the processor 62. A thirteenth operation 66 then sends the image to the receiving mobile telephone 10 and terminates in exit 68. The ninth operation 50 also transfers control to the thirteenth operation 66.

The activities of the processor 62 under instruction from the eleventh operation 60 can be many and varied. For example, if a receiving microprocessor 10 does not have a particularly large depth of colour, the processor 62 can be instructed to reduce the number of binary digits used to define the colour of a pixel in the displayed image. If the display 22 on the receiving mobile telephone 10 is of a particularly low resolution, the processor 62 can be instructed to send only every other pixel, or to merge pixels to reduce the number by half. Other numbers are also possible.

These examples are given only by way of example and are not intended to constitute a limitation.

Attention is drawn to FIG. 4, showing a flowchart illustrating how, having accommodated a particular network and receiving radio telephone 10, a transmitting server, according to the present invention, is capable, automatically, to adapt to varying bandwidth and other conditions found on the network.

From entry 70, a fourteenth operation 72 elicits the maximum values for each of the parameters of the frame of the moving image. That is to say, the server 18 learns, for example, the maximum number of horizontal pixels, the maximum number of vertical pixels, the maximum number of bits defining the colour of a pixel, the maximum frame rate, etc. In other words, the fourteenth operation 72 calls forth the parameters which would define highest possible quality resolution of the image. The fifteenth operation 74 then compares the maximum parameter values which can be attained by the image with the material available to the server 18 with the values of the image parameters possessed by the receiver. The fifteenth operation 74 thus calls forth the best resolution which can be obtained on the receiving mobile telephone 10. A sixteenth operation 76 then equalises the values of the image parameters of the fourteenth operation 72 with the values of the receiver parameters of the fifteenth operation 74. This obtains, or gets at least a close approximation to, the selected image quality of the operation shown in FIG. 3. All things being equal, the result at the end of the sixteenth operation 76 would be the sent image from the thirteenth operation 66 of FIG. 3. However, it is essential to take account of the variable bandwidth available.

A fourth test 78 checks to see if the resulting signal is compatible with the channel down which it is to be sent. If it is, that is to say, the channel does not have restricted bandwidth, or a lesser bandwidth that would normally be capable of being handled by the receiving mobile telephone 10, a seventeenth operation 80 transmits the frame and terminates the operation through exit 82. If, however, the fourth test 78 detects that the signal it is proposed to transmit is not compatible with the instantaneous condition of the channel, a fifth test 84 looks to see if the proposed signal carries an excessive amount of colour. The human eye is sensitive to gross changes of hue, but is quite insensitive to quite gross changes in saturation, of a colour. Accordingly, if the fifth test 84 detects, say, that the signal proposes to use a large number of pigment-defining data bits (for example, 42 or 24) when a perfectly reasonable result would be obtained with a lesser number of pigment-defining binary digits, for example, 12, an eighteenth operation 86 reduces the number of colour-defining binary digits and returns control back to the fifth test 84. If the colour is still excessive and the signal is still not compatible with the channel, further reduction of the number of colour-defining binary digits is undertaken until either the colour is no longer excessive and the signal is compatible with the channel, or the colour is no longer excessive but the signal is still not compatible with the width of the channel.

Control then passes to a sixth test 88 where the proposed transmitted signal is, once again, examined to see if it is consistent with the bandwidth and other restrictions on the channel.

If it is still not narrow enough to pass through the channel in its present condition, another quality is chosen by which the actual quality of the signal can be reduced with minimal impact on the perceived quality. In this example, for the next stage, it is elected to reduce the resolution of the picture displayed on the screen 22.

The human eye's awareness of resolution of a screen image varies widely. Very young children have acute but unaware resolution. As age progresses, up to the mid or late twenties, vision is both acute and practised. Beyond the thirties, vision becomes less acute. Ocular acuteness is measured, in the individual, as the minimum solid angle which can be individually resolved. From the screen's 22 point of view, display acuteness the size of the smallest item which can be individually perceived by a viewer at the minimum viewing distance. There is a lot of leeway in the viewing parameters for the screen 22. The screen 22 is seldom viewed from as short a distance as the minimum viewing distance. The minimum viewing distance is generally set for a shortest focal distance which is less than half of the mean shortest focal distance for the population. All this means that, all things being equal, it would probably be possible to reduce the acuteness of the image by a factor of at least four or eight before half of the population noticed any degradation whatsoever.

Therefore, a nineteenth operation 90 reduces the acuteness of the resolution of the frame of the pixel density of the moving image to be sent. It does this, for one example, by electing to omit every Nth pixel element in the vertical and horizontal direction. The mapping is then redistributed over the original number of pixels. In N=5, a 20% linear loss of actual resolution is achieved. Simpler regimes, for another example, can be achieved by transmitting only every Mth pixel in a vertical, a horizontal, or both directions. Where a pixel was omitted, the previously transmitted pixel is simply substituted. With this example, quite dramatic band width reductions can be achieved for little loss of actually perceived image detail. The invention can include any means whereby the acuteness of the displayed image can be reduced.

At each stage of reduction of resolution, the nineteenth operation 90 returns control to the sixth test 88. Control only passes to a seventh test 92 whenever either the signal, which it is proposed to transmit, is compatible with the channel or the signal is not compatible with the channel but has reached a lower limit of pixel density (displayed acuteness) beyond which it is not advisable to go.

Control then passes to a seventh test 92 which, yet again, looks to see if the proposed signal for transmission is compatible with the bandwidth and other restrictions on the channel. If it is not, as a final measure, in this example, a twentieth operation 94 elects to reduce the frame repetition rate. This can only be taken so far. The human eye is sensitive to flicker, in general, for images presented below ten or twelve per second. Certain individuals can detect flicker at image presentation rates up to 25 per second. Very few human individuals detect flicker at presentation rates above this. Reduction in frame repetition rate can be made towards the rates indicated. At each pass, a low frame rate test 93 checks to see if the frame rate has reached a lower boundary below which it is not allowed to fall.

If even this measure fails, a twenty-first operation 96 suppresses the transmission of that frame.

If, however, this measure is successful, the seventh test 92 passes control to the seventeenth operation 80 which transmits the frame.

While the action of FIG. 4 has been described in terms of testing signals to see if they fit through a band width of the channel, it is to be appreciated that the same result, within the invention, can be achieved by simply calculating what changes need to be made to the ideal signal and applying those changes prior to transmission. The explanation of FIG. 4 is given in the manner that it is in order to facilitate understanding.

The various measures, taken to reduce the bandwidth of the signal, while shown as being applied in separate epochs in this example, can be applied together. For example, the colour can be reduced, together with a little loss of resolution, and a little further loss of colour, and some, all or none of each possible type of bandwidth reduction measure, applied in turn, until a signal, sufficiently low in bandwidth to be transmissible via the channel, is obtained. Once again, the same result can be achieved, within the invention, by means of calculation.

To summarise, clarify and re-iterate what has been described with reference to FIG. 4: the action of FIG. 4 is to create an image consistent with the best quality that the receiving mobile telephone 10 is capable of receiving or of the best quality that the channel, unrestricted, can carry. This is the “ideal” frame or image. In a perfect world, this is the frame or image which would be sent and received.

However, the bandwidth available to transmit the frame or image is not necessarily wide enough to transmit the ideal frame or image. Up to a certain number of subscribers on a base station, there may be no problem, each subscriber being allocated a fixed, adequate amount. Beyond a certain number of subscribers on a base station, the bandwidth allocated to each subscriber can be reduced.

Thus, in order to accommodate the reduction in bandwidth which the agglomeration of subscribers on a base station may engender, various qualities of the image are reduced until an image signal is provided capable of being carried (or not) within the bandwidth. In this instance, purely by way of example, and non-exclusively, the depth of colour, followed by the displayed pixel density and, finally, the frame rate, are all reduced until a signal is obtained which fits within the bandwidth allocated to a particular receiving mobile telephone 10. These measures are chosen purely by way of non exclusive and non exhaustive example. Those skilled in the art will be aware of other measures which can be applied. All that is required, from the point of view of the present invention, is that a measure can be applied which reduces the bandwidth of the signal to be transmitted without rendering the quality of the displayed signal unacceptable. Other, non limiting, examples include reduction of a colour image to a grey or black and white image, and freezing the displayed image for that frame and subsequent frames.

While the invention has been described with reference to transmission of a single frame, or a group of frames, in a broadcast of an animated image in a mobile telephone network from a server 18 to a receiving mobile telephone 10, it is to be appreciated that the present invention is also applicable to transmission of any kind of image or data The adopted measures may be set up frame by frame, or block by block, or may be set up and maintained for a predetermined time to allow for changes in base station bandwidth as with varying subscriber numbers, or may be set up and maintained for a session. The measures can be triggered to change as the bandwidth of the system alters. Certain subscribers or mobile telephone 10 types can have a higher category of access, whereby they enjoy no cutoff and/or higher bandwidth while lower category subscribers risk having their signal frozen or cut off as bandwidth reduces.

1-12. (canceled)

13. An apparatus for sending an image related signal to a receiving device, said apparatus comprising:
means for learning the characteristics of the receiving device;
means for employing said learned characteristics to select a version of said image related signal;
means to create said version of said image related signal; and
means for sending said version of said image related signal to the receiving device.

14. An apparatus according to claim 13, further comprising:
means for determining the bandwidth of the medium connecting said apparatus and said receiving device, and
means for adjusting characteristics of said version of said image related signal for the adjusted version of the image related signal to fit within the determined bandwidth.

15. An apparatus according to claim 14, further comprising means for determining the sending capacity of the apparatus.

16. An apparatus according to claim 13, wherein the characteristics, learned about said receiving device, include at least one of the group comprising: receiver memory capacity; receiver display size; receiver colour depth; receiver processor availability and receiver display resolution.

17. An apparatus according to claim 14, wherein said adjustable characteristics include at least one of the group comprising: depth of colour; resolution; and frame rate.

18. A combination of an apparatus according to claim 13 and a receiving device, wherein the receiving device is one of the group comprising: a mobile telecommunications device, a computer device and a television device.

19. A method for sending an image related signal to a receiving device from an apparatus, said method including the steps of: learning the characteristics of the receiving device; employing said learned characteristics to select a version of said image related signal; creating said version of said image related signal; and sending said version of said image related signal to the receiving device.

20. A method according to claim 19, further comprising the steps of:
determining the bandwidth of the medium connecting said apparatus and said receiving device; and
adjusting characteristics of said version of said image related signal for the adjusted version of the image related signal to fit within the determined bandwidth.

21. A method according to claim 20, including the further step of determining the sending capacity of the apparatus.

22. A method according to claim 19, wherein the characteristics, learned about said receiving device, include at least one of the group comprising: receiver memory capacity; receiver display size; receiver colour depth; receiver processor availability and receiver display resolution.

23. A method according to claim 20, wherein said adjustable characteristics include at least one of the group comprising: depth of colour; resolution; and frame rate.

24. A method according to claim 19, for use where the receiving device is one of the group comprising: a mobile telecommunications device, a computer device and a television device.

25. An apparatus for sending an image related signal to a receiving device, said apparatus comprising:
a learning module for learning the characteristics of the receiving device;
a selector module arranged to employ said learned characteristics to select a version of said image related signal;
a composer module to create said version of said image related signal; and
a transmitter module arranged to send said version of said image related signal to the receiving device.

26. An apparatus for sending an image related signal to a receiving device, said apparatus comprising:
means for learning the characteristics of the receiving device;
means for determining the bandwidth of the medium connecting said apparatus and said receiving device;
means for determining the sending capacity of the apparatus;
means for employing said learned characteristics to select a version of said image related signal;
means to create said version of said image related signal; and
means for adjusting characteristics of said version of said image related signal for the adjusted version of the image related signal to fit within the determined bandwidth and the sending capacity of the apparatus; and
means for sending said version of said image related signal to the receiving device.

27. An apparatus for sending an image related signal to a receiving device, said apparatus comprising:
means for learning the characteristics of the receiving device; wherein the characteristics, learned about said receiving device, include at least one of the group comprising: receiver memory capacity; receiver display size; receiver colour depth; receiver processor availability and receiver display resolution;
means for employing said learned characteristics to select a version of said image related signal;
means to create said version of said image related signal; and
means for sending said version of said image related signal to the receiving device.
